(19) United States
(12) Patent Application Publication
(10) Pub. No.: US 2009/0237919 A1
(43) Pub. Date: Sep. 24, 2009

(54) ILLUMINATING DEVICE

(75) Inventor: CHUN-WEI WANG, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/242,598

(22) Filed: Sep. 30, 2008

(30) Foreign Application Priority Data
Mar. 24, 2008 (CN) 200810300690.7

(51) Int. Cl. F21L 4/00

(52) U.S. Cl. 362/183

(57) ABSTRACT

An illuminating device, includes a board, a plurality of lights, a rechargeable battery, a first circuit, a second circuit, and a switch. The board has a first surface and a second surface at an opposite side of the board to the first surface. The light sources are mounted on the first surface of the board. The rechargeable battery is mounted on the second surface of the board. The first circuit is configured for electrically connecting the light sources to mains power. The second circuit is configured for electrically connecting the light sources to the rechargeable battery. The switch is configured for controlling the light sources to be selectively connected to the first circuit or the second circuit.

### TECHNICAL FIELD

The present invention relates to an illuminating device, and particularly to an illuminating device using dual power supply system.

### DISCUSSION OF RELATED ART

Light emitting diodes (LEDs) have many advantages, such as high luminance, low power consumption, compatibility with integrated circuits, long-term reliability, and environmental friendliness so that LEDs have become widely used as light source.

LED devices are generally powered by commercial power. Input of the LED devices is direct current (DC), which is commutated from alternating current (AC) of the commercial power. However, when commercial power is cut-off, the LED devices also stop working, which causes inconvenience to its users.

What is needed therefore, is an illuminating device to overcome the above described shortcomings.

### SUMMARY

An illuminating device, includes a board, a plurality of lights, a rechargeable battery, a first circuit, a second circuit, and a switch. The board has a first surface and a second surface at an opposite side of the board to the first surface. The light sources are mounted on the first surface of the board. The rechargeable battery is mounted on the second surface of the board. The first circuit is configured for electrically connecting the light sources to mains power. The second circuit is configured for electrically connecting the light sources to the rechargeable battery. The switch is configured for controlling the light sources to be selectively connected to the first circuit or the second circuit.

### BRIEF DESCRIPTION OF THE DRAWINGS

Many aspects of the present illuminating device can be better understood with reference to the following drawings. The components in the drawings are not necessarily drawn to scale, the emphasis instead being placed upon clearly illustrating the principles of the present illuminating device. Moreover, in the drawings, like reference numerals designate corresponding parts throughout the several views.

FIG. 1 is a schematic view of an illuminating device in accordance with a first embodiment.

FIG. 2 illustrates a circuit diagram of the illuminating device in FIG. 1.

FIG. 3 is a schematic view of an illuminating device in accordance with a second embodiment.

FIG. 4 illustrates a circuit diagram of the illuminating device in FIG. 3.

### DETAILED DESCRIPTION OF EMBODIMENTS

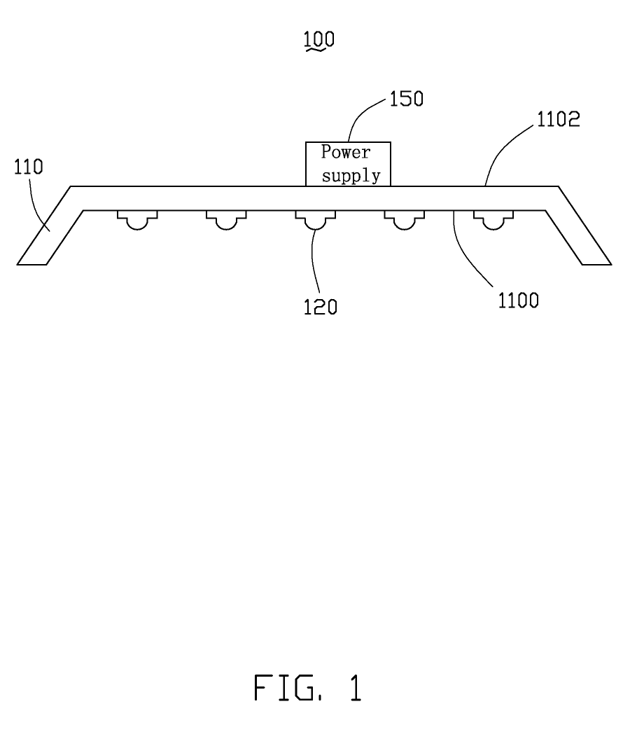

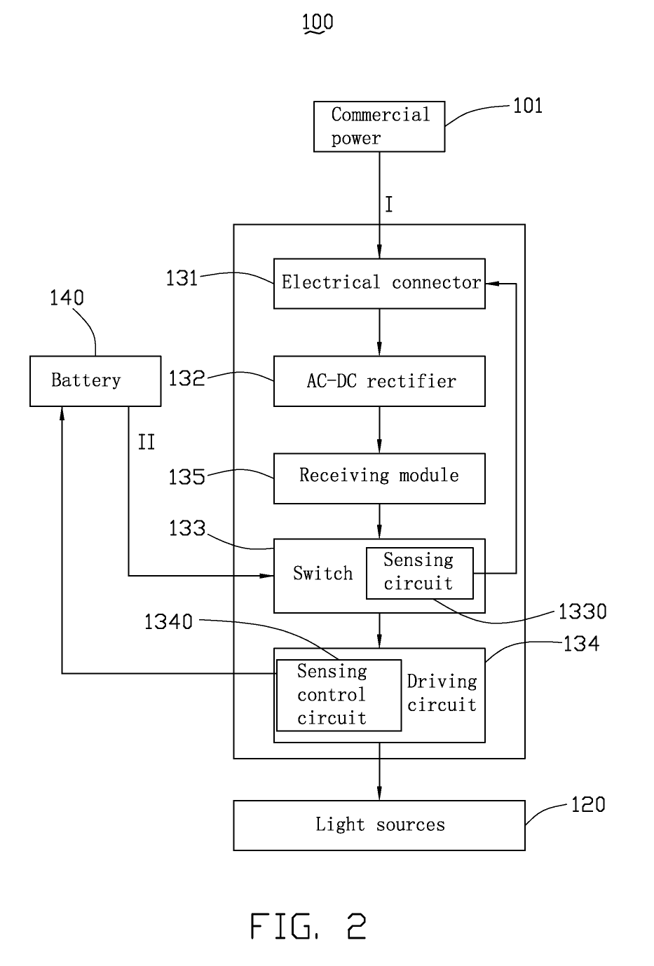

Referring to FIGS. 1 and 2, an illuminating device 100 in accordance with a first embodiment is shown. The illuminating device 100 includes a body 110 having a first surface 1100 and a second surface 1102, at least one light sources 120 mounted on the first surface 1100 of the body 110, and a power supply 150 electrically connected with the light sources 120. The power supply 150 can be mounted on the second surface 1102 of the body 110.

The power supply 150 includes an electrical connector 131, an AC-DC rectifier 132 electrically connected to the electrical connector 131, a switch 133 for the AC-DC rectifier 132, and a driving circuit 134 electrically connected to the switch 133. The driving circuit 134 is electrically connected with the light source 120. In the present embodiment, the light source 120 is an LED light source.

The power supply 150 further includes a commercial power 101 and a battery 140. The commercial power 101 is electrically connected to the electrical connector 131. The rectifier 132 is configured for converting alternating current (AC) to direct current (DC). The rectifier 132 may be made of solid state diodes, vacuum tube diodes, mercury arc valves, and other components. The commercial power 101, the electrical connector 131, the rectifier 132, the switch 133, and the driving circuit 134 together form a first circuit

The battery 140 is electrically connected to the switch 133. The battery 140, the switch 133, and the driving circuit 134 form a second circuit II.

The switch 133 is selectively connected with the first circuit I or the second circuit II. When the switch 133 connects with the first circuit I, the light source 120 can be powered by the commercial power 101. When the switch 133 connects with the second circuit II, the light source 120 can be powered by the battery 140.

The switch 133 can includes a sensing circuit 1330. The sensing circuit 1330 is configured for sensing whether there is electricity flowing from the commercial power 101 to the light source 120. When the sensing circuit 1330 detects there is electricity flowing from the commercial power 101 to the light source 120, the sensing circuit 1330 sends a signal to the switch 133 to control the switch 133 to disconnect with the battery 140, so that the light source 120 is only powered by the commercial power 101. When the sensing circuit 1330 detects there is no electricity flowing from the commercial power 101 to the light source 120, the sensing circuit 1330 sends a signal to the switch 133 to control the switch 133 to connect with the battery 140, so that the light source 120 is only powered by the battery 140.

The battery 140 can be a rechargeable battery, also known as a storage battery. The battery 140 can be charged by the commercial power 101.

The power supply 150 further includes a receiving module 135. The receiving module 135 is electrically connected to the rectifier 132 and the switch 133. The receiving module 135 is configured for receiving controlling signals or commands from external device, such as a remote controller. The receiving module 135 sends the controlling signals or commands to the driving circuit 134 to control the intensity of the light source 120 or control the light source 120 to be turned on/off.

The driving circuit 134 further includes a sensing control circuit 1340 electrically connected to the battery 140. The sensing control circuit 1340 is configured for sensing the charge capacity of the battery 140 when the battery is in working mode, and controlling the amount of electricity supplied to the light source 120 by the battery 140, thereby lasting the lighting hours of the light source 120. When the sensing control circuit 1340 determines that the charge capacity of the battery 140 is less than a predetermined charge capacity, the sensing control circuit 1340 generates a control signal to the driving circuit 134. The driving circuit 134 then decreases the amount of electricity supplied to the light source 120.

In summary, the power of the illuminating device 100 can be selectively supplied by the commercial power 101 and the battery 140. Under normal conditions, the light sources 120 are lit by the commercial power 101, and the battery 140 is in a charge state. In the event of a commercial power outage, the battery 140 can be used as a backup power source to power the light sources 120.

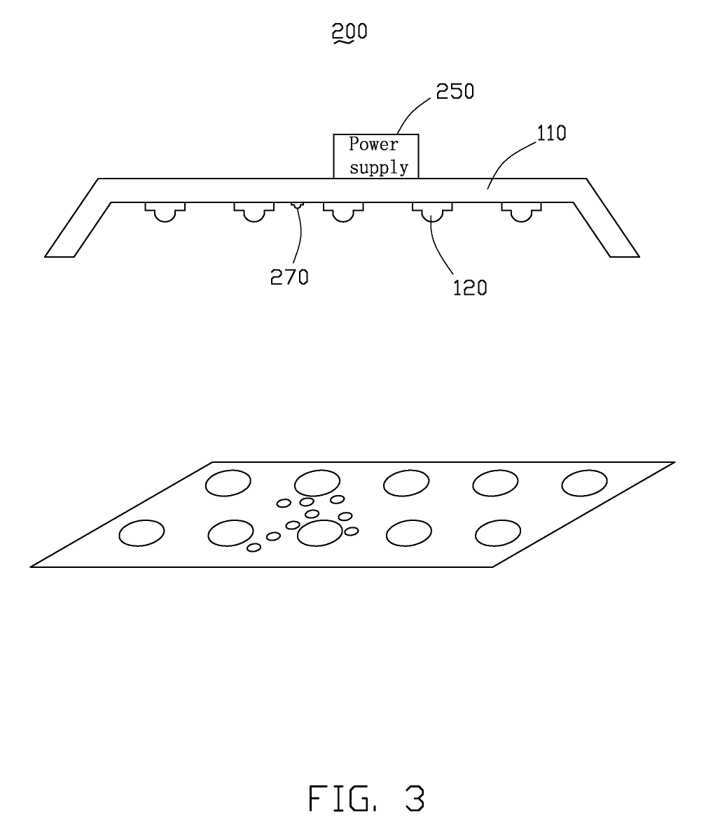

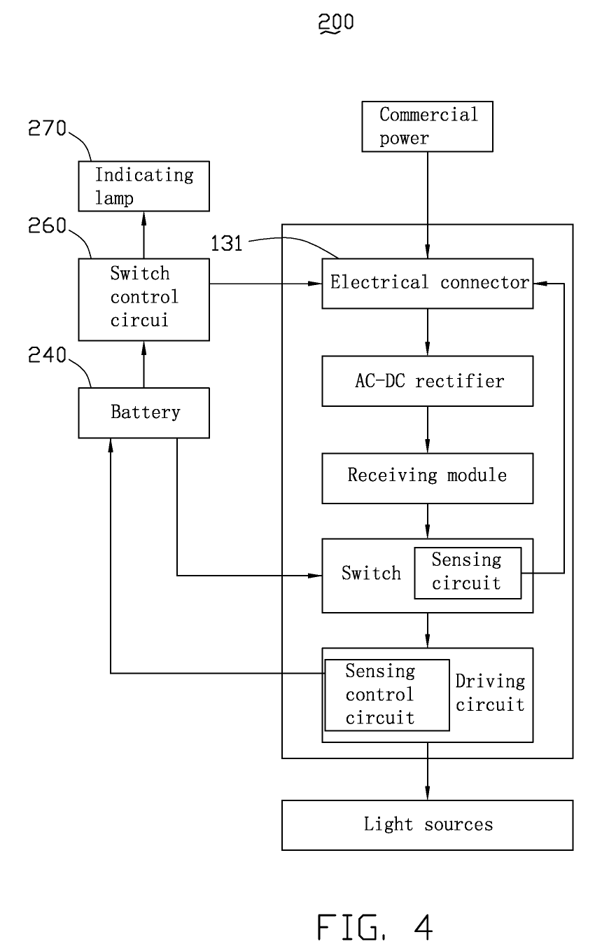

Referring to FIGS. 3 and 4, an illuminating device 200 in accordance with a second embodiment is shown. The illuminating device 200 includes a body 110, at least one light sources 120 mounted on the body 110, an indicating lamp 270 mounted on the body 110, and a power supply 250 electrically connected with the light sources 120 and the indicating lamp 270. In the present embodiment, the indicating lamp 270 can emit lights shaped as an arrow.

In the second embodiment, the power supply 250 is substantially similar with the power supply 150 of the first embodiment, the difference is that the power supply 250 further includes a switch control circuit 260 electrically connected between the indicating lamp 270 and the battery 140. The battery 140 also electrically connects to the electrical connector 131. The switch control circuit 260 is configured for sensing whether there is electricity flowing from the commercial power 101 to the light source 120. When the switch control circuit 260 detects there is electricity flowing from the commercial power 101 to the light source 120, the switch control circuit 260 disconnects with the battery 140 and the indicating lamp 270. When the switch control circuit 260 detects there is no electricity flowing from the commercial power 101 to the light source 120, the switch control circuit 260 connects with the battery 140 and the indicating lamp 270. That is, in the event of commercial power outage, the indicating lamp 270 can be lit by the battery 240 to denote a way out of a building for people.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. An illuminating device, comprising:
a board having a first surface and a second surface at an opposite side of the board to the first surface,
a plurality of light sources mounted on the first surface of the board,
a rechargeable battery mounted on the second surface of the board,
a first circuit for electrically connecting the light sources to mains power,
a second circuit for electrically connecting the light sources to the rechargeable battery, and
a switch for controlling the light sources to be selectively connected to the first circuit or the second circuit.

2. The illuminating device of claim 1, wherein the light sources are light-emitting diodes.

3. The illuminating device of claim 1, wherein the first circuit comprises an electrical connector for being connected to the mains power, a rectifier for converting alternating current of the mains power to direct current, and a driving circuit, the switch being connected between the rectifier and the driving circuit.

4. The illuminating device of claim 1, further comprising a sensing circuit for sensing an electric current flowing from the mains power to the light sources and sending a signal associated therewith so as to control the switch to be connected to the rechargeable battery or the mains power based on the signal.

5. The illuminating device of claim 1, further comprising a receiving module electrically connected between the rectifier and the switch, and configured for receiving controlling signals from a user to control an intensity of light from the light source or control the light sources to be turned on/off.

6. The illuminating device of claim 1, further comprising a sensing control circuit electrically connected to the rechargeable battery, the sensing control circuit being configured for sensing charge capacity of the rechargeable battery and controlling amount of electricity supplied to the light sources by the rechargeable battery based on the charge capacity of the rechargeable battery.

7. The illuminating device of claim 1, further comprising an indicating lamp mounted on the first surface of the board and electrically connected with the light sources.

8. The illuminating device of claim 7, wherein the indicating lamp emits light which forms an arrow-shaped pattern.
